(19) United States
(12) Patent Application Publication
(10) Pub. No.: US 2024/0208172 A1
(43) Pub. Date: Jun. 27, 2024

(54) AXIAL MISALIGNMENT DETECTION SYSTEM

(71) Applicant: BIRIM MAKINA SANAYI VE TICARET ANONIM SIRKETI, Kemalpasa, Izmir (TR)

(72) Inventor: Aykut KARAHAN, Bornova, Izmir (TR)

(21) Appl. No.: 17/996,472

(22) PCT Filed: Mar. 2, 2022
(86) PCT No.: PCT/TR2022/050185

§ 371 Date: Oct. 18, 2022

(30) Foreign Application Priority Data
Dec. 6, 2021 (TR) 2021/019144

(51) Int. Cl. B30B 15/28; B30B 9/32

(52) U.S. Cl. CPC B30B 15/28; B30B 9/326

(57) ABSTRACT

Provided is a detection system for use in scrap metal shears, which contains a guillotine for cutting scrap metal materials that applies pressure from above on scrap metal materials by a pressing piston and fixed bottom blades that cut scrap metal materials between the guillotine which acts in downward direction and the fixed bottom blades. The system has at least one sensor which is positioned on the scrap metal shear in such a way that it faces sensor reference points designated on the guillotine to follow the cutting axis, detect axial misalignment during the cutting operation and send a signal; and a PLC system which monitors the scrap metal shear and processes the signal received from the sensor to stop the scrap metal shear or warn the operator.

### FIELD OF THE INVENTION

The present invention relates to a system for detecting axial misalignment in scrap metal shears.

More specifically, the invention relates to an axial misalignment detection system for detecting axial misalignment of the scrap metal shear during the cutting operation and warning the operator.

### PRIOR ART

Scrap metal shears are widely used in scrap yards to cut scrap metal materials. Said scrap metal shears basically comprise a guillotine, which moves between the guides to cut scrap metal by using the cutting power generated by pistons; a frame (cutting station), which holds the fixed blades located under the guillotine; and a feeding section. Axial misalignment occurs in state-of-the-art scrap metal shears due to a problem known as “loosening” which means material to be cut gets in between the guillotine and bottom blades instead of getting cut. Main cause of this event is the wear in blades, which further mounts extra weight on piston rod and guides. In existing applications, loosening and axial misalignment are monitored manually. Therefore, there is a need to develop a system that can automatically detect axial misalignments in the machine, allowing for necessary actions to be taken.

According to the literature review, the patent application no. U.S. Pat. No. 4,253,388 can be shown as an example of prior art, which relates to a machine for cutting scrap metal. The invention more specifically relates to a method and a machine for compressing and cutting random loaded scrap metal.

In conclusion, the drawbacks explained above and the shortcomings in existing solutions to the problems have necessitated improvement in the related technical field.

### SUMMARY OF THE INVENTION

The present invention relates to an axial misalignment detection system which eliminates the disadvantages described above while bringing new benefits to the technical field.

The primary aim of the invention is to provide a system which detects axial misalignment of the scrap metal shear during the cutting operation and warns the operator.

Another aim of the invention is to ensure detection of axial misalignment by a sensor during the cutting operation, warn the operator through the PLC system, stop the scrap metal shear or allow for different actions to be taken.

A further aim of the invention is to automate the manual tracking of axial misalignment in scrap metal cutting operation, thereby eliminating issues regarding manual tracking.

In order to achieve the aims set out above and in the detailed explanation below, the invention relates to a detection system for use in scrap metal shears, which contains a guillotine for cutting scrap metal materials that applies pressure from above on scrap metal materials by means of a pressing piston and fixed bottom blades that cut scrap metal materials between the guillotine which acts in downward direction and the fixed bottom blades, further comprising:
at least one sensor which is positioned on the scrap metal shear in such a way that it faces sensor reference points designated on the guillotine to follow the cutting axis (e), detect axial misalignment (k) during the cutting operation and send a signal;
a PLC system which monitors the scrap metal shear and processes the signal received from the sensor to stop the scrap metal shear or warn the operator.

The below drawings and the detailed description set out with reference to the accompanying drawings provide for a clearer understanding of the structural and characteristics properties and all benefits of the present invention; therefore, the evaluation needs to take these drawings and the detailed description into account.

### BRIEF DESCRIPTION OF THE DRAWINGS

FIG. 1a shows a front view of the guillotine of the detection system according to the invention.

FIG. 1b shows a side view of the guillotine of the detection system according to the invention.

FIG. 1a shows a rear view of the guillotine of the detection system according to the invention.

FIG. 2 shows a top view of the guillotine of the detection system according to the invention.

FIG. 3 shows a representative view of the guillotine and bottom blade of the detection system according to the invention during the scrap metal cutting operation.

FIG. 4 shows a representative view of the cutting of scrap metal material by the guillotine and bottom blade of the detection system according to the invention.

FIG. 5 shows a representative view of the scrap metal material loosening (getting in between the guillotine and bottom blade) during the scrap metal cutting operation by the guillotine and bottom blade of the detection system according to the invention.

FIG. 6 shows a representative view of scrap metal material, guillotine and bottom blade of the detection system according to the invention in the event of axial misalignment.

### LIST OF REFERENCE NUMERALS

10. Guillotine
20. Bottom blade
30. Piston rod
40. Sensor reference point
50. PLC system
e. cutting axis
k. axial misalignment

### DETAILED DESCRIPTION OF THE INVENTION

For a better understanding of the invention, this detailed description demonstrates the preferred embodiments of the detection system in a non-limiting manner.

In its most basic form, the detection system according to the invention comprises a guillotine (10) at the cutting station of the scrap metal shear that applies pressure from above on scrap metal materials by means of a pressing piston (30) and cuts scrap metal materials by means of a bottom blade (20), a sensor which faces sensor reference points (40) designated on the guillotine (10), detects axial misalignment (k) during the cutting operation and sends a signal, and a PLC system (50) which monitors the scrap metal shear and processes the signal received from the sensor to stop the scrap metal shear or warn the operator.

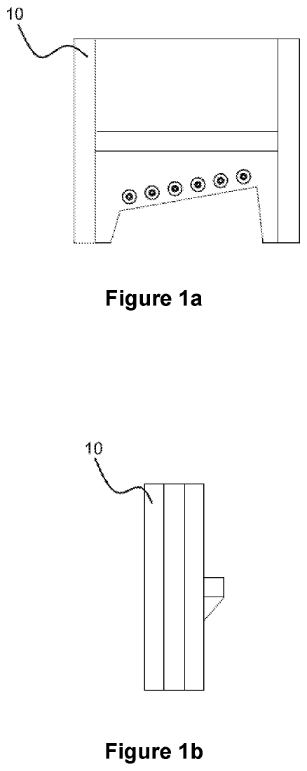

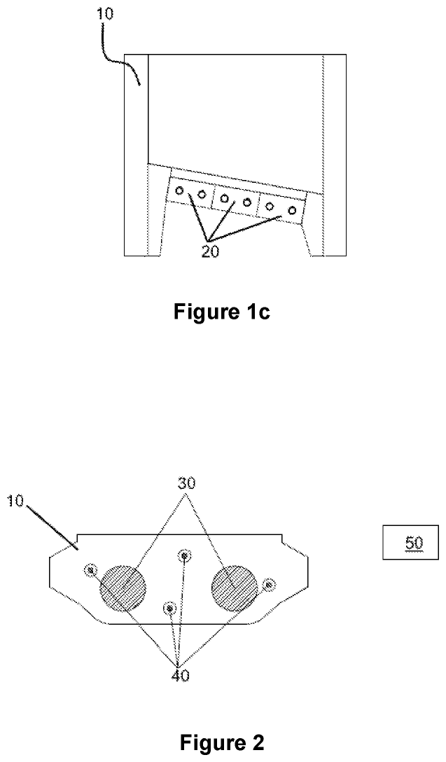

As shown in FIGS. 1a, 1b and 1c, the cutting station of the scrap metal shear comprises a guillotine (10) for cutting scrap metal materials that applies pressure from above on scrap metal materials by means of a pressing piston (30) and fixed bottom blades (20) that cut scrap metal materials between the guillotine (10) which acts in downward direction and the fixed bottom blades (20).

As shown in FIG. 2, sensor reference points (40) are designated on the guillotine which applies pressure from above on scrap metal materials by means of a pressing piston (30) and sensors are positioned on scrap metal shear right above said sensor reference points (40) in such a way that they face sensor reference points (40). Said sensors follow the 20) cutting axis (e), detect axial misalignment (k) during the cutting operation and send a signal.

The operational regime of the scrap metal shear is controlled by means of the PLC system (50). Said PLC system (50) processes the signal received from the sensor to stop the scrap metal shear or warn the operator.

### The Working Principle of the Detection System According to the Invention is as Follows:

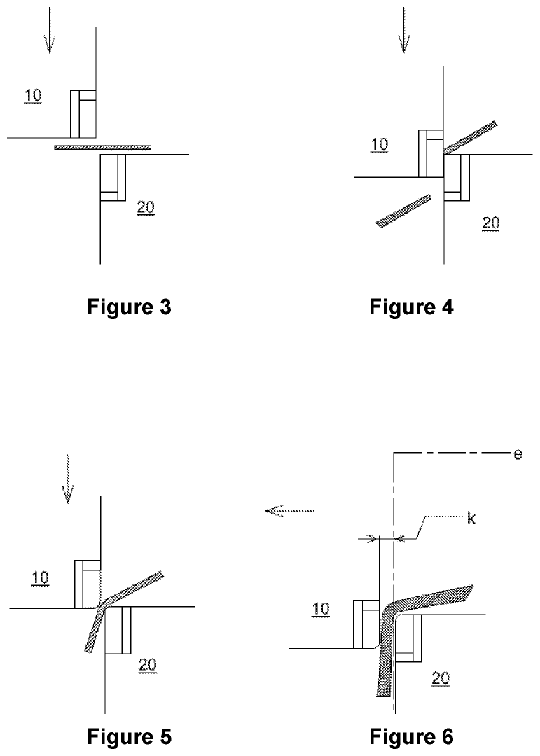

As shown in FIG. 3, the guillotine (10) acts in downward direction to cut the scrap metal material and the scrap metal material is cut as shown in FIG. 4.

As shown in FIG. 5, in case of loosening (material to be cut getting in between the guillotine and bottom blade) in the scrap metal shear, sensors follow the cutting axis (e) 30) during the downward movement of the guillotine (10) and detect axial misalignment (k) as shown in FIG. 6 and send a signal to the PLC system (50). Then, the PLC system (50) stops the scrap metal shear or warns the operator.

1. A detection system for use in scrap metal shears, which contains a guillotine for cutting scrap metal materials that applies pressure from above on scrap metal materials by means of a pressing piston and fixed bottom blades that cut scrap metal materials between the guillotine which acts in downward direction and the fixed bottom blades, the detection system comprising:
at least one sensor which is positioned on the scrap metal shear in such a way that it faces sensor reference points designated on the guillotine to follow a cutting axis, detects axial misalignment during the cutting operation and sends a signal; and
a PLC system which monitors the scrap metal shear and processes the signal received from the sensor to stop the scrap metal shear or warn an operator.
